(19) United States
(12) Patent Application Publication
(10) Pub. No.: US 2004/0100151 A1
(43) Pub. Date: May 27, 2004

(54) Wireless in-line low-voltage controller

(76) Inventor: Brain John Smyth, Phoenix, AZ (US)

Correspondence Address: Brain Smyth, 39614 N. 1st Street, Phoenix, AZ, 85086, US

(21) Appl. No.: 10/696,363

(22) Filed: Oct. 30, 2003

Related U.S. Application Data
(60) Provisional application No. 60/423,751, filed on Nov. 6, 2002.

(51) Int. Cl. H01H 3/00

(52) U.S. Cl. 307/139

(57) ABSTRACT

A transmitter (20,21), that may be hand-held, transmits radio frequency signals to a receiver within a low-voltage controller device (31, 32, 33, 34, 35). This controller device is installed in-line with the low-voltage power source (22, 23, 24, 25), and the low-voltage load (26, 27, 28, 29, 30). The system allows the user to remotely switch on and off individual controller devices, or a plurality of controller devices depending the address assigned at the transmitter and receiver. One aspect of the device is that it is installed in the low-voltage line, and therefore allows the user a more versatile control system than other devices.

### CROSS-REFERENCE TO RELATED APPLICATIONS

| | | |
|---|---|---|
| 4,371,814 | January 1983 | Hannas |
| 5,160,924 | November 1992 | Jean-Pierre et al. |
| 5,565,855 | October 1996 | Knibbe |
| 5,936,362 | August 1999 | Alt et al. |
| 5,977,882 | November 1999 | Moore |
| 6,377,001 B2 | April 2002 | Levy |
| 6,424,096 B1 | July 2002 | Lowe et at. |
| 6,424,660 B2 | July 2002 | Jacobson, Jr. |

### BACKGROUND OF THE INVENTION

1. Field of the Invention

This invention relates to an in-line control system that can be used to remotely switch low-voltage devices on and off.

2. Description of Prior Art

In home and office, low-voltage devices are powered from the secondary side of a transformer that has its primary side plugged into a 110-120 volt outlet. The secondary side of this transformer (low-voltage side) powers devices such as indoor and outdoor lighting, security systems, sprinkler systems, and other low-voltage devices. Multiple devices such as a plurality of lights may be powered from a single transformer. Wireless switching circuits typically switch the primary side of the transformer. When the primary side of the transformer is switched on or off, the entire system, or plurality of lights, is switched on or off. In many situations the user requires a single transformer with multiple “zones” containing one, or a plurality of devices, that can be controlled independently of other “zones” containing one, or a plurality of devices. In these situations the switching device must be downstream of the transformer.

Another limitation of the prior art is that in some low-voltage systems a timer is used to automatically turn the low-voltage devices on and off at various times throughout the day; if the primary side of the transformer is switched off the timer stops, and even if power is restored it no longer switches the devices at the correct time.

Still other prior art consists of complex and expensive centralized automation systems for controlling low-voltage devices. Most wireless home automation systems that control the low-voltage circuit still require wired connections to centralize the system. A centralized low-voltage system is typically hard-wired during the construction phase; it is very difficult and costly to install these systems after construction is completed. Also, since the devices that need to be controlled are typically located in the vicinity where the user wants to switch them, centralized wireless systems can be problematic if the devices being controlled are far from the central receiver.

Because of these and other limitations, there remains a need for a simple, inexpensive, wireless in-line switch that can control low-voltage power, or the secondary side of a low-voltage transformer.

### BRIEF SUMMARY OF THE INVENTION

The present invention relates to a novel wireless in-line low-voltage switching system that is used to switch on and off a single or a plurality of low voltage devices. This switching device, or controller, can be used in both alternating current and direct current systems. In circuits wired with a low-voltage transformer, the controller switches devices from the secondary side of the transformer. Multiple controllers can be wired to multiple transformers, or multiple controllers can be wired to a single transformer, which allows a plurality of uniquely controlled zones on the same transformer. Each controller can be set to the same address, different addresses, or a combination thereof that gives the user flexibility that was not available with prior art. Because the system switches the secondary side of the transformer, downstream of any timers, the timers are not affected when using this system. Low-voltage direct current (DC) systems often times do not have a transformer, and the controllers can be wired directly in-line with the power source and the load. If they do have a transformer, they can be wired in-line between the load and the secondary side of the transformer.

The in-line controllers can be turned on and off using a wireless remote transmitter that sends the command signal with an address specific to a single, or a plurality of in-line controllers. In the preferred embodiment the signal is sent to the controller, or receiver, from a hand-held radio frequency transmitter. Unlike the centralized systems, the in-line controller, which contains the receiver, can be installed anywhere between the low-voltage power supply and the load. This allows the receiver, contained within the controller, to be located in close proximity to where the user would typically control the devices.

The current invention is very easy to install both before and after construction since it is simply spliced in-line with the same wiring required for the low-voltage devices; no additional wiring is needed for the invention.

The invention is a simple, cost effective solution to having a versatile wireless control system that is easily installed in both existing and new low-voltage systems.

### BRIEF DESCRIPTION OF THE DRAWINGS

FIG. 1 is an electrical schematic of the radio frequency (RF) remote transmitter portion of the invention.

FIG. 2 is an electrical schematic of the RF receiver/controller portion of the invention.

FIG. 3 illustrates one example of a low-voltage lighting application of the invention.

FIG. 4 illustrates one example of an automotive application of the invention.

### DETAILED DESCRIPTION OF THE PREFERED EMBODIMENTS

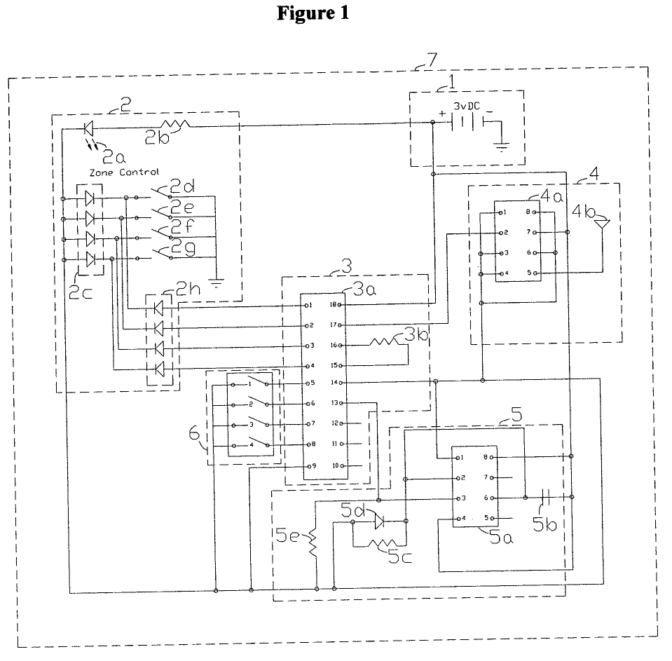

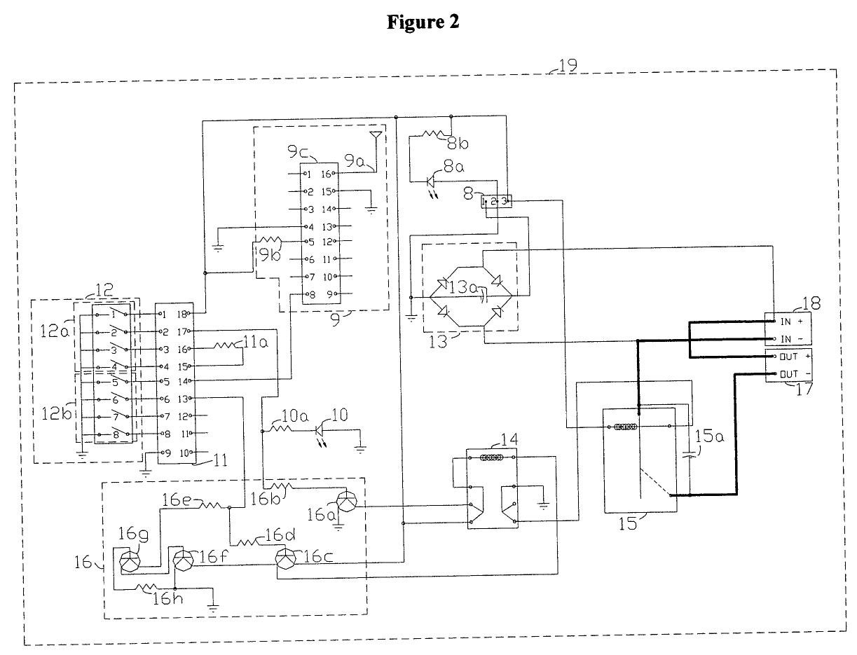

FIG. 1 shows the preferred embodiment of the remote control portion 7 of the invention that comprises an RF transmitter within a compact housing used to command the preferred embodiment of the controller portion of the invention 19 shown in FIG. 2, also within a compact housing. The housings may be made of some type of rugged plastic. The invention consists of electronic components assembled using conventional wiring, and/or printed circuit boards or similar means.

Referring now to FIG. 1. A conventional battery 1 that may be 3 volts powers the remote 7. The remote 7 comprises a switching circuit 2 that is manually controlled by the user, using either one, or a plurality, of switch buttons 2d, 2e, 2f, and 2g. Each switch is connected to ground and may independently ground a singular pin (1,2,3, or 4) of the encoder integrated circuit (IC) 3a, through diodes 2h, when a button switch is thrown. Alternatively, a plurality of switches can be thrown such that a 4-bit combination of pins on encoder 3a would be grounded through a plurality of diodes 2h. Each switch 2d, 2e, 2f, 2g may also provide ground paths to one, or a plurality, of components in the remote 7 as shown in FIG. 1. Each switch is isolated from other switches using diodes 2c. A light emitting diode (LED) 2a indicates when a switch is thrown. Resistor 2b is connected to the LED and the positive side of the battery, and may have a value of 249 ohms. Alternatively, the switching section 2 could be automated using a programmable timer circuit, other programmable integrated circuit, or computer interface without changing the scope of this invention. The battery 1 may also be replaced with a conventional power supply without changing the scope of this invention.

The encoder section 3 of the remote 7 may comprise a Holtek HT-12E encoder IC 3a, and an oscillator resistor 3b that may have a value of 750 k ohms. The encoder IC 3a receives input from the switching section 2, the 4-bit coding section 6, and the data section 5. In this embodiment, the switching section 2 is used to input into the encoding IC 3a a user selection based on positions of the button switches 2d, 2e, 2f, and 2g. The coding section 6 is used to input into the encoder IC 3a a user-selectable code assigned to the individual remote transmitter. Together, the IC 3a encodes a signal that may have a unique address. In this embodiment, pins 1-4 of the encoder IC 3a are assigned as user button switches and pins 5-8 are assigned as the user-selectable remote identification, however, any combination of button switches and ID switches could be assigned without changing the scope of this invention. Data may be input into the encoder IC 3a on pins 10, 11, 12, and 13. One pin, or a plurality of pins, complete the 4-bit data input of encoder IC 3a. In the preferred embodiment, the data section 5 may consist of a 555 timer IC 5a that is configured using the capacitor 5b that may have a value of 10 mF, the resistor 5c that may have a value of 150 k ohms, and the diode 5d. The output of the timer IC 5a results in either a high or low signal input into the encoder IC 3a on pin number 13. One side of resistor 5e is connected to encoder IC 3a on pin 13 and timer IC 5a on pin 3, and may have a value of 2.2 k ohms. The other side of resistor 5e is connected to a plurality of components as shown in FIG. 1. The timer output may be set to switch states approximately 2 seconds after one of the button switches 2d, 2e, 2f, or 2g are thrown. The encoder IC 3a outputs the encoded address from pins 1-8 and the data from pins 10-13 to the transmitter portion 4 on pin 17 of the encoder IC 3a. The transmitter IC 4a accepts the encoded signal and transmits it using conventional means, i.e., using an antenna 4b. The antenna 4b may be externally mounted on the remote housing, internally concealed within in the housing, or a combination thereof. If any switch 2d, 2e, 2f, or 2g is closed, power will be applied to the components within the remote 7 such that a radio frequency will be emitted from the antenna 4b with the 8-bit address encoded from pins 1-8 of encoder IC 3a and the 4-bit data encoded from pins 10-13 of encoder IC 3a.

It should be noted that one feature of the preferred embodiment of the remote 7 is that a controller, or plurality of controllers, can be switched from one state to the other state by either pressing the button switches 2d, 2e, 2f, or 2g and releasing the button switches in less than a prescribed amount of time, or pressing the button switches 2d, 2e, 2f, or 2g and releasing the button switches after a prescribed amount of time. Furthermore, the preferred embodiment of the remote 7 allows either one, or a plurality of controllers, to be switched from a remote location, and that a unique address can be set using switch buttons 2d, 2e, 2f, 2g and dip switches 6.

Referring now to FIG. 2. The in-line controller 19 receives the transmitted signal from one or a plurality of said remotes using an external antenna mounted to the controller housing, an internal antenna concealed within the controller, or a combination thereof.

The controller 19 includes input terminals 18 that can be connected to transformers, timers, controllers, or other devices that provide a low-voltage power source. Low voltage is typically considered below 50 volts however the controller may typically be used in applications requiring 6 volts to 30 volts. In the preferred embodiment, the power source may be either alternating current (AC) or direct current (DC), and does not change the scope of the invention. Loads connected to the output terminals 17 may include lights, lighted signs, relays, motors, and any other low-voltage loads.

The controller consists of four diodes set up as a rectifier 13 for converting input power for the electronics from AC to DC. The rectifier uses a capacitor 13a that may have a value of 1000 mF. If the input power is DC, the rectifier portion of the controller does little to the input power signal. An electronic power supply 8 provides the majority of electronics comprised in controller 19 with 5 volts. An LED 8a provides an indication of 5-volt power. Resistor 8b may have a value of 680 ohms. Controller 19 comprises a receiver section 9 with an antenna 9a that receives the RF signal from the aforementioned remote. The receiver IC 9c has a power resistor 9b that may have a value of 200 ohms. The receiver IC 9c provides the decoder IC 11 with the address and data transmitted from the remote. The decoder IC 11 compares the complete address transmitted from the remote, and if it is consistent with the switch settings 12, the decoder IC 11 passes the transmitted data on pins 10-13. The complete controller address is selectable with a plurality of switches 12. In many applications a plurality of switches 12a may be used to set the specific controller to a specific button switch on the remote, while another set of switches 12b may be used to set the controller to a specific remote. The oscillator resistor 11a for the decoder 11 may be 33 k ohms. An LED 10 is connected to pin 17 of decoder IC 11 through a resistor 10a, which may have a value of 680 ohms, and will illuminate if the decoder IC 11 receives a signal with an address that matches the controller switches 12. Pin 17 of said decoder IC 11 is also connected to a resistor 16b, which may have a value of 2.2 k ohms, which is connected to the base of transistor 16a. The transistor 16a has its emitter grounded and its collector connected to the latching relay 14 as shown in FIG. 2.

Dependant upon the transmitted signal from the aforementioned remote, the output of the decoder IC 11 on pin 13 will be either high or low. The data may be output on one, or any number of pins 10-13 of encoder IC 11 without changing the scope of this invention. In the preferred embodiment pin 13 of the decoder IC 11 is connected to resistors 16d, and 16e. Resistors 16d, 16e, and 16h may have a value of 2.2 k ohms. The base of transistor 16g is connected to resistor 16h, its emitter is connected to the base of transistor 16f, and its collector connected to resistor 16e. Transistor 16f has its base connected to the emitter of transistor 16g, its emitter grounded, and its collector connected to the emitter of transistor 16c. Transistor 16c has its base connected to resistor 16d, its emitter connected to the collector of transistor 16f and the coil of latching relay 14, and its collector connected to 5-volt power. The basic function of section 16 of the controller 19 is to process the high or low output signal, and the receiver signal (high when receiving data), from the decoder IC 11 and control the latching relay 14. The latching relay 14 remains in its predisposed state until the decoder IC 11 outputs a high or low signal on pin 13. Dependant upon the state of the latching relay 14, a signal may also be needed (to switch said latching relay) on pin 17 of encoder IC 11. Furthermore, since the relay 14 is a latching relay, removing power from the controller at the input terminals 18 will not change the latching relay position unless power is restored and an RF signal is received with the correct address and appropriate data.

The latching relay 14 may be a single pole double throw (SPDT). The second throw of the latching relay 14 passes the control coil signal used for throwing the main relay 15. The main relay 15 passes one leg of the input power supply that is connected to the input terminals 18 to one leg of the load, which is connected to the output terminals 17. In the preferred embodiment the other leg of the power supply connected to the input terminals 18 is passed directly to the load that is connected to the output terminals 17. The other side of the coil for the main relay 15 is connected to the 5-volt power supply. Capacitor 15a may have a value of 10 mF. This switching scheme can be modified without changing the scope of the invention.

It should also be noted that one feature of the preferred embodiment of the controller is that the state of the latching relay 14 will remain in its predisposed state even when power is removed from the input terminals 18. The main relay 15 will be switched, if required, by the latching relay 14 when power is returned to the input terminals 18 such that the main relay returns to the state it was in previous to the power loss at the input terminals 18. Furthermore, the preferred embodiment of the controller 19 is powered from the input terminals 18 and no additional power source is needed for its operation.

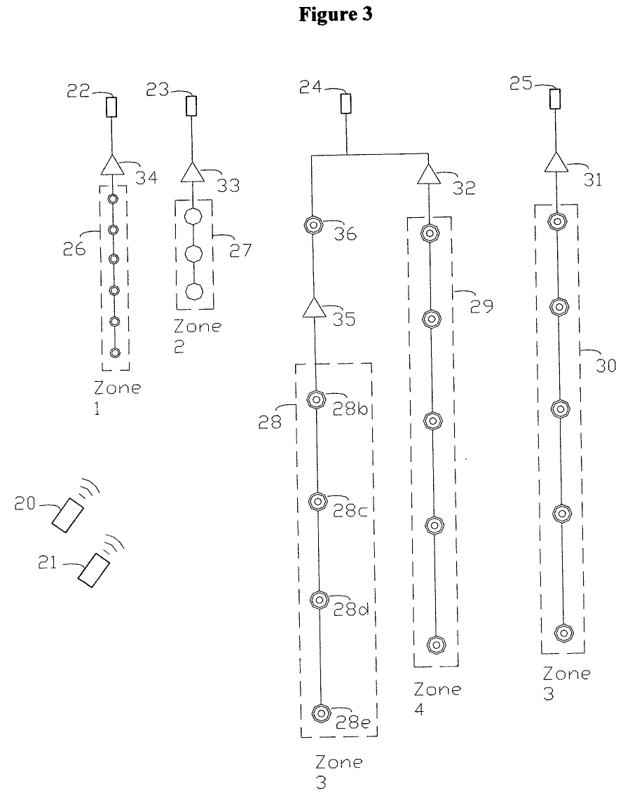

Now referring to FIG. 3 which illustrates one application of the preferred embodiments of the remote 7 and the controller 19, also referred to as the controller system. This example shows how a plurality of low-voltage lights, both indoor and outdoor, can be controlled in a plurality of zones. The controller system can easily be installed in either a new, or an existing, commercial or residential installation. Four low-voltage transformers 22, 23, 24, and 25, are shown, and typically convert 110/120 volts AC to between 12 volts and 15 volts AC. Light dimmers may also be used to decrease the transformer output voltage. A plurality of low-voltage lights are wired together using conventional means to complete a plurality of light strings 26, 27, 28, 29, and 30. A plurality of controllers 31,32, 33, 34, and 35 are wired in-line between the low-voltage power supply and the lights that are being controlled. Each of four button switches located on the remote transmitters 20 and 21 can control either one, or a plurality of light strings. Multiple remote transmitters can be used but only one is needed to control all of the zones. The remotes could contain more or less button switches without changing the scope of this invention.

Zone one 26 may be switched on and off by controller 34 with a single button switch located on one remote 20 or a plurality of remotes 20, 21. Zone two 27 may be switched on and off by controller 33 with a single button switch located on one remote 20 or a plurality of remotes 20, 21. A plurality of controllers wired in-line with separate transformers located in separate locations can be set to the same zone. Zone three comprises two light strings 28 and 30 that may be controlled using a single button located on one remote 20 or a plurality of remotes 20, 21. A controller can be placed in-line at any location where the lights that are wired downstream need to be controlled remotely. Lights 28b, 28c, 28d, 28e comprise a part of zone three and are controlled with the rest of the lights set to zone three 30 while light 36 is not controlled by controller 35. A single power supply transformer 24 can be wired with a plurality of controllers 32, 35. Zone four 29 may be switched on and off by controller 32 with a single button switch located on one remote 20 or a plurality of remotes 20, 21. A plurality of remotes 20, 21 can be set to control the same zones or different zones within the same proximity. If the remotes and controllers have unique addresses, one set of remotes and controllers will not interfere with the other. Two remotes are shown in FIG. 3 however many more could be added without changing the scope of this invention.

Some sprinkler systems control solenoid valves using a voltage that may be in the range of 26.5 volts AC. The light strings in the previous example could be replaced with electric solenoid valves such that a sprinkler system could be controlled much like the light strings.

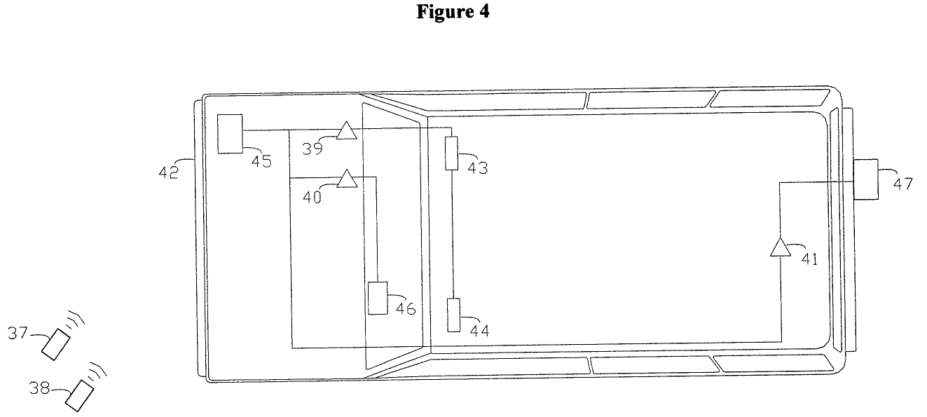

Now referring to FIG. 4 that illustrates one automotive application of the preferred embodiments of the remote 7 and the controller 19. Most automobile electric systems are 12 volts DC, some are 6 volts DC but the controllers would be applied in the same fashion. A power supply, that may be the vehicle's main battery 45 can be connected to one, or a plurality of controllers 39, 40, 41 that are onboard the vehicle 42. The controllers 39, 40, 41 are connected in-line with the battery 45 or some sub-system of the vehicle's electrical system, and the load that is to be controlled. In this example, one controller 39 is wired such that two lights, that may be original equipment or an aftermarket upgrade, are controlled so that they can be turned on and off using one remote 37, or a plurality of remotes 37,38. A second controller 40, that may be set to operate using a different address (a second remote button switch) is wired such that it controls the switched power wire of a stereo amplifier 46 using one remote 37, or a plurality of remotes 37, 38. A third controller 41, that may be set to operate using another different address (a third remote button switch) different from the previous two controllers 39, 40 is wired such that it controls a winch 47 using one remote 37, or a plurality of remotes 37, 38. Other devices can also be controlled in a similar fashion and may include, but is not limited to, hydraulic controllers, alarms, or relays. The remote and controller system can be used in a similar fashion for controlling devices on Motorcycles and other vehicles. FIG. 4 illustrates one example but a plurality of remotes and controllers can be wired to operate numerous other devices on vehicles in a similar fashion.

With these and other applications, the controller can also be wired as a switch to control a high-current relay, or a plurality of relays. This may be required, but is not limited to applications where low-voltage, high-current devices need to be switched by a single controller. The voltages stated in the previous applications can vary but the scope of the invention does not change since all applications would still be considered low-voltage.

Wireless in-line or series switches are shown in prior art however this new invention has several advantages: this invention is specifically designed for low-voltage applications, it can easily be installed in new and existing low-voltage systems without running additional wires, it provides simple means of controlling one, or a plurality of switches, with one, or a plurality of transmitters, and the invention can be manufactured very inexpensively. For these and other reasons this new invention provides a simple means of creating a versatile low-voltage control system.

Another feature of the preferred embodiments of this invention is that by setting the address switches of the remotes to different settings, multiple remotes can be used in proximity to other remotes without interference. Controllers can then be set to respond to only specific remotes set to the same address.

The illustrated applications of the preferred embodiments are only a few examples of typical uses for this invention. Other applications might include control of alarms, doorbells, motorized window coverings, and the like. My intention is not to limit the invention to these specific applications since low-voltage remote controls can be applied in many situations.

What I claim as my invention is:

1. A method of remotely switching on and off low-voltage electrical power provided to a single low-voltage load or a plurality of low-voltage loads comprising an electrical circuit connected between the low-voltage power supply, or secondary side of a transformer providing low-voltage power, and the low-voltage load, that switches power downstream of the circuit on and off using a remote radio frequency transmitter.

2. A method according to claim 1 wherein the switching device can be assigned an address, that may be unique, such that with a single radio frequency transmitter the user can switch on and off one, or a plurality, of switching devices.

3. A method according to claim 2 wherein the switching device is powered by the low-voltage power supply.

4. An in-line low-voltage electrical circuit according to claim 1 comprising:
a. means of switching the low-voltage power downstream of the electrical circuit on and off;
b. means of receiving and decoding a radio frequency control signal transmitted from a remote source, which may be a hand-held transmitter.

5. An in-line low-voltage electrical circuit according to claim 4 wherein the circuit comprises a means of being assigned an address, that may be unique, such that with a single radio frequency transmitter the user can switch on and off the low-voltage power downstream of one, or a plurality of such circuits.

6. An in-line low-voltage electrical circuit according to claim 5 wherein the circuit is powered by the low-voltage power supply.

7. An in-line low-voltage electrical circuit according to claim 6 wherein the switching portion of the circuit latches in the on or off position.

8. An in-line low-voltage electrical circuit according to claim 7 wherein the switching portion of the circuit remains latched in the on or off position even if the low-voltage power supply is interrupted; the circuit may also accomplish this by returning to the previous on or off position once the low-voltage power is restored.
